(19) United States
(12) Patent Application Publication
(10) Pub. No.: US 2020/0361179 A1
(43) Pub. Date: Nov. 19, 2020

(54) Layered Removable Graffiti Skin

(71) Applicants: Michael Schuch, Anaheim, CA (US); Jeffrey Green, Anaheim, CA (US)

(72) Inventors: Michael Schuch, Anaheim, CA (US); Jeffrey Green, Anaheim, CA (US)

(21) Appl. No.: 16/934,642

(22) Filed: Jul. 21, 2020

Related U.S. Application Data
(63) Continuation of application No. 15/296,899, filed on Oct. 18, 2016.
Application No. 15/296,899 is a continuation-in-part of application No. 14/831,655, filed on Aug. 20, 2015.
Application No. 14/831,655 is a continuation-in-part of application No. 14/195,347, filed on Mar. 3, 2014, now abandoned.
(60) Provisional application No. 61/890,484, filed on Oct. 14, 2013.
(60) Provisional application No. 61/772,674, filed on Mar. 5, 2013.

(51) Int. Cl. B32B 7/06; B32B 7/12; B32B 27/36; B32B 15/09; B32B 15/20; B32B 27/08; B32B 3/26; B32B 27/32; B32B 15/18; B44C 1/10; B32B 15/08

(52) U.S. Cl. CPC B32B 7/06; B29C 63/02; B32B 27/36; B32B 15/09; B32B 15/20; B32B 27/08; B32B 3/266; B32B 27/32; B32B 15/18; B44C 1/105; B32B 15/08; B32B 2255/10; B32B 2255/26; B32B 2307/416; B32B 2307/41; B32B 2451/00; B32B 2607/00; Y10T 428/24802; B32B 2307/412; B32B 2307/414; Y10T 428/1462; B32B 2307/748; B32B 7/12

(57) ABSTRACT

Improvements in a graffiti covering skin are disclosed the covering skin is formed from multiple layers of transparent or filtering layers that can be individually removed to provide a new layer without graffiti or damage. Each layer of the skin provides different functions to provide a material that covers existing graffiti and creates a new surface that reduces or repels future graffiti from being placed on the original host surface. One of the layers can be a visual pattern layer that provides the desired appearance of a hard surface of stainless steel, mirror, wood, color, marble, granite or light filtering. This layer provides a structural rigidity that maintains dimensional stability. The skin is backed with a removable adhesive that is removed from the host surface without leaving a residue. Each skin is measured and cut to the desired size before placement in a host surface.

This application is a continuation of U.S. application Ser. No. 15/296,899, filed Oct. 18, 2016, which is a continuation-in-part of U.S. application Ser. No. 14/831,655, filed Aug. 20, 2015, which is a continuation-in-part of U.S. application Ser. No. 14/195,347, filed Mar. 3, 2014, which in turn claims priority to U.S. Provisional Application 61/890,484 filed Oct. 14, 2013, and U.S. Provisional Application 61/772,674 filed Mar. 5, 2013.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a film covering with removable outer layers to remove graffiti, damage, scratches, wear and tear on a host surface, to reduce future vandalism and simulates, improves or modifies the surface it covers. More particularly, the present covering skin provides a multi-layered skin that is thick enough to cover surface scratches.

Most public places are susceptible to damage by vandals. Vandalism can take many forms including but not limited to tagging by paint, markers and scraping. For all of these forms of vandalism the outer surface becomes cosmetically altered. When the damage is from painting or markers the surface can be chemically cleaned. Often the cleaning process creates further damage to the surface. For damage caused by scraping or scratching the surface, cleaning is not effective, and sanding the surface may remove legibility of the markings, the surface will still be cosmetically unpleasing. The vandalism can be scratches to counters, elevators, walls, wood, metal and glass surfaces.

Proactive efforts to cover a transparent glass surface, such as a window or mirror, require covering one or both sides of the glass surface with a covering or skin that is easily removable and replaceable without significantly altering the opacity of the glass or window. Some prior art discloses a window treatment that provides filtering of the light through a window. These filter skins are placed on the inside of the window and are destroyed when removed and can't be reused. These filtering films further are fragile and can be easily damaged by vandals thereby making them ineffective against vandalism because they are more easily damaged.

A number of patents and or publications have been made to address these issues. Exemplary examples of patents and or publication that try to address this/these problem(s) are identified and discussed below.

U.S. Pat. No. 6,540,952 issued on Apr. 1, 2003 to james A LaPoint et al., discloses a Laser ablation of multiple layers. The method of providing multiple arcuate ablations on a corner portion of a polymeric laminate. The laminate includes more than one layer, with each layer having an exposed upper surface. just the edges have ablations, as opposed to holes that require a tool to remove a layer.

U.S. Pat. No. 6,461,709 issued on Oct. 8, 2002 and U.S. Pat. No. 6,777,055 that issued on Aug. 17, 2004, both to Jeffrey R. Janssen et al., and discloses a Graffiti and/or environmental protective article having removable sheets, substrates protected therewith, and a method of use. The invention relates to an article comprising a transparent stack of sheets that may be applied, for example, to protect substrates such as glass or plastic windows, signage or displays. A topmost sheet can be peeled away after it is damaged to reveal an undamaged sheet below. This patent discloses a film that is optically clear and allows the visibility of the host surface to be visible through the multiple layers.

What is needed is a covering that simulates the appearance of the surface they cover and covers surface damage such as, but not limited to cover graffiti, damage, scratches, wear and tear on a host surface such as but not limited to escalator sides, elevators, doors, windows, walls, counters and restroom partitions. The proposed Graffiti covering skin provides the solution with a removable skin that simulates or covers the original surface and covers any existing graffiti and surface damage.

### BRIEF SUMMARY OF THE INVENTION

It is an object of the layered removable graffiti skin to be formed from multiple layers of different materials. Each layer of the graffiti covering skin provides different functions to provide a material that both covers existing graffiti, damage, scratches, wear and tear on a host surface and creates a new surface that reduces or repels future graffiti from being placed on the original host surface.

It is an object of the layered removable graffiti skin to provide a cosmetic appearance of smooth, mirror, textures, wood grain, marble, and granite, color, filtering, brushed or textured surface. At least one of the layers is a thin layer of cosmetic material or a layer that provides the appearance of a mirror, stainless steel, wood grain, marble, granite, color, mirror or transparent surface. The cosmetic appearance can be from printing, painting, screening, brushing, or other processes. This layer provides a structural rigidity that maintains dimensional stability. It reacts like a sheet of material that is much thicker than the individual layer of material that is being used. The thickness of the graffiti covering skin is sufficient to cover imperfections, scratches or gouges in the surface that is being covered.

It is still another object of the layered removable graffiti skin for each skin to be measured and cut to the desired size before placement on the host surface. Each host surface is pre-measured to determine the optimal size and shape of the graffiti covering skin. The skin or skins can be cut and fabricated at a factory that is located away from the site of installation, or can be fabricated, modified or trimmed at the place of installation. The skin or skins can then be transported or moved to the host surface for installation where the backing skin is removed and placed onto the host surface. The removable sacrificial layers can be removed by the business owner.

It is another object of the layered removable graffiti skin to utilize acrylic or PSA adhesives. These adhesive allow removal of a single layer without leaving an adhesive residue on the remaining sheets.

It is still another object of the layered removable graffiti skin for each skin to provide light filtering or obscuring. The light filtering reduces utility costs and damage caused by harmful sunlight rays that enter an unprotected window. The skin can be placed on one or both sides of a storefront window, or transportation vehicle window such as a train or bus to provide damage protection from vandals that may attack the outside of the business as well as provide protection on the inside of the business window. Because the skin can be easily removed and replaced it is contemplated that the amount of window filtering can be altered at different times of the year to provide high levels of sun filtering in summer months and low levels of filtering in winter months when outside sunlight is less.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows the layers of the laminate.

FIG. 2 shows a table of the process settings that were used for boring the holes in FIG. 1.

FIG. 3A-3C show cross-sectional views the film with different obliterated layers.

FIG. 4 shown the steps used to cover an existing base mirror, window, wall or surface.

### DETAILED DESCRIPTION OF THE INVENTION

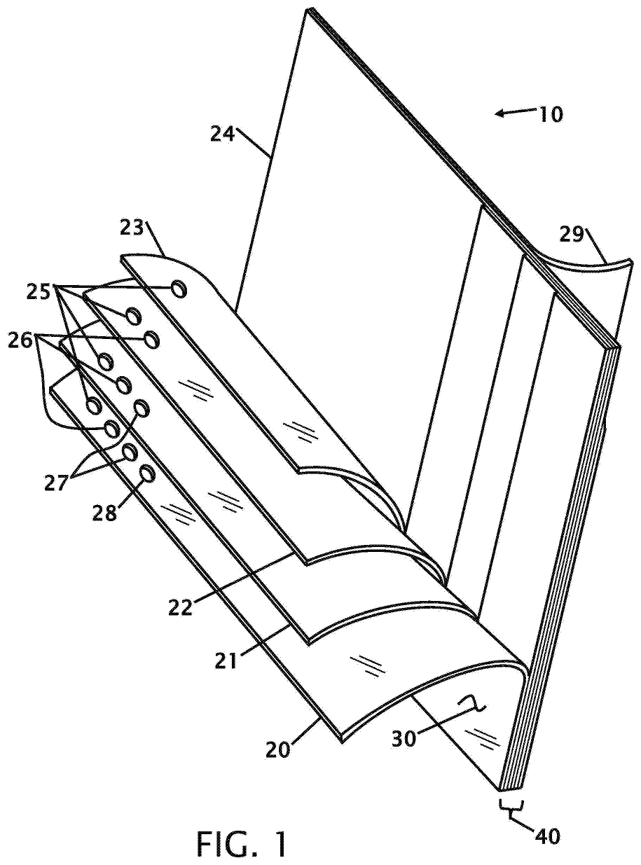

FIG. 1 shows the construction layers of the graffiti covering skin 10. In this preferred embodiment the graffiti covering skin 10 may have an outer layer comprising a protective coating or film that protects the inner layer(s) from damage in transit or installation. The outer layer 30 that can also be satin, flat, high gloss, paper or other material or finish that can aid in installation. The protective surface is transparent or translucent and may be colored to provide a tint to any underlying layers. This outer surface 30 repels some damage from vandalism and is provides a smooth cosmetic surface for protection of the next layer. The outer surface is also acid resistant.

The next layers 20, 21, 22 and 23 are removable transparent, translucent or opaque layers and may also include a visual pattern or filtering overlay. In one preferred embodiment, the bottom layer 24 is a stainless steel or reflective mirror overlay or has an outer cosmetic surface that has the desired appearance and texture. In some embodiments this can be a brushed finish, a satin finish, a mirror, a reflective or other finish as desired or specified by the customer. It is also contemplated that this surface can be a screened, printed or painted surface of material that simulates the desired stainless steel, copper, brass, wallpaper or other desired surface to match an existing substrate. The appearance of covered surface can be changed, as an example of an elevator being changed from bronze to stainless steel to provide an updated appearance. The exterior surface is not applied in a thermal vacuum formed process. While painting is disclosed as a possible surface coating on the outer surface of the overlay, the overlay is not paint that is applied directly to a surface. The overlay is also not intended for use on painted walls or surfaces. The overlay is further not intended to be a discoloration barrier.

In another preferred embodiment the visual pattern is smooth, textured, wood grain, marble, granite, colored appearance. The pattern can simulate the underlying hard surface or can change the appearance of the underlying surface for example changing the interior of an elevator from stainless steel to wood grain. It is further contemplated that the visual pattern can be light filtering to provide UV or other filtering that provides light protection to the interior of the building and or reduces cooling expenses.

This layer 24 provides a structural rigidity that maintains dimensional stability. It reacts like a sheet of material that is much thicker than the individual layer of material of stainless steel that is being used. The thickness of the graffiti covering skin 40 is sufficient to cover imperfections, scratches or gouges in the surface that is being covered.

The multilayer film works with medical visors, helmets and other uses wherein dirt, debris, scratches or contamination of the viewing surface results in serious issues and requires prompt, easy and rapid removal to restore visual acuity. The multiple layers 20, 21, 22 and 23 allow fast easy removal of damaged layers or surface contamination. Each layer has thick construction allows face shields to hold their shape. The removable layers leave no residue on underlying layer of face shield. Each layer 20, 21, 22 and 23 is 100 micron HC PET. Each layer is bonded together with no air gaps in construction results in high visible light transmission.

To produce the holes 25, 26 and 27, a Universal Laser Systems PLS6.75, with a 50 watt, 9.3 pm C02 laser and a 2.0 lens. It is also contemplated to utilize a blade driven CNC to layers and holes. Compressed air/gas is directed along the path of the laser beam. The cone protects the focusing optics, cools material and prevents flame up of smoke and fumes. A Downdraft Cutting Table is designed to support material on an open honeycomb surface and exhaust smoke and fumes from both sides of the material being processed to produce cleaner cut edges and reduce marring of the back surface of the material. When used in conjunction with air/gas assist and a cone, compressed air/gas helps direct smoke and fumes through the cut and then into the exhaust path incorporated in the downdraft cutting table.

The release liner 29 is removable secured to the back of the removable adhesive (R.A.) layer 24. This release liner 29 is removed from the bonded layer prior to installation of the graffiti covering skin on the host surface.

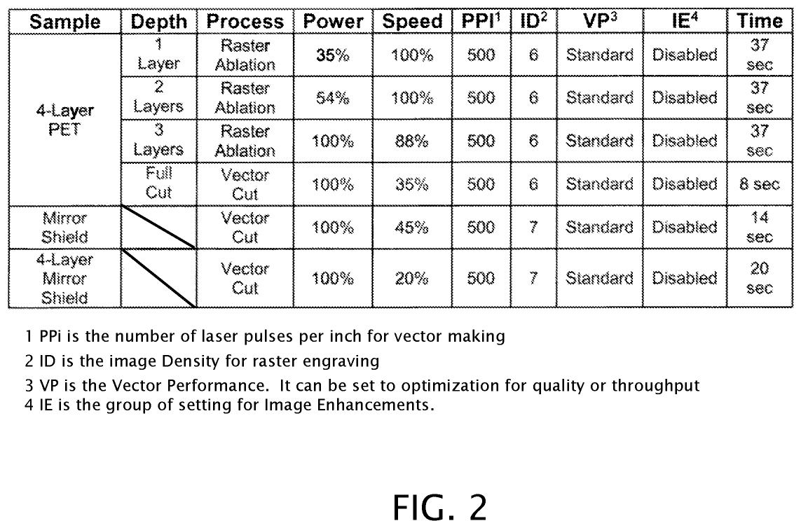

FIG. 2 shows a table of the process settings that were used for boring the holes 25, 26 and 27 in FIG. 1. This table shows the power, speed and image density that is used to obliterate material for the desired number of layers to be removed. Removal of holes generally require the use of a tool to remove a specific layer. This prevents a person from “picking” at an edge to remove a layer.

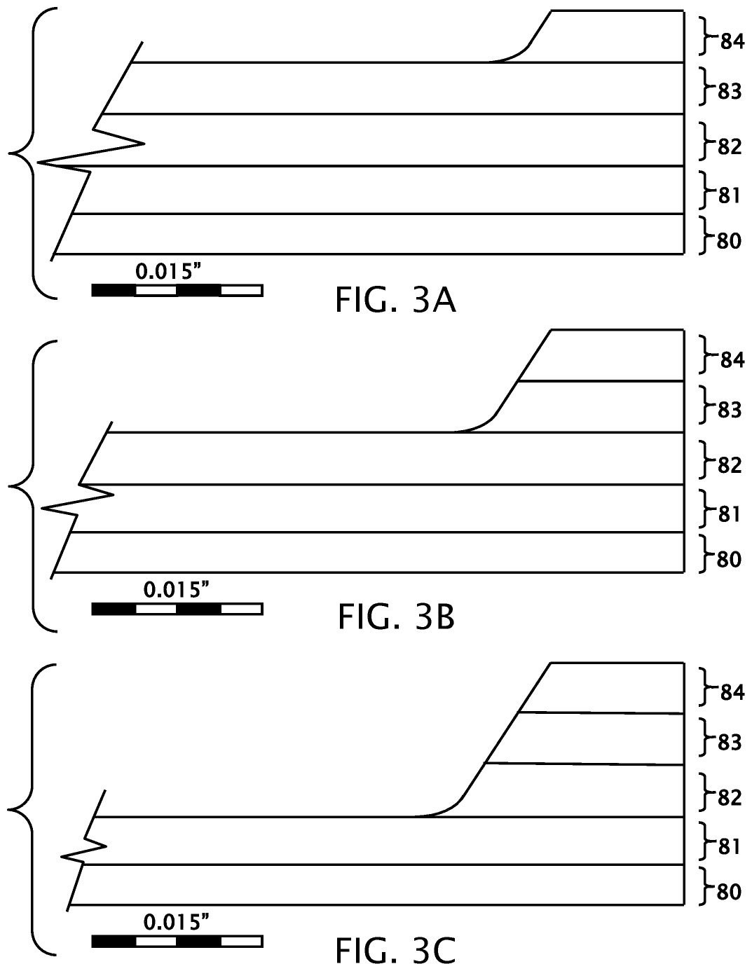

FIG. 3A-3C show cross-sectional views the film with different obliterated layers. In these figures, micrographs (1 SOx) of the layer 84, layer 83, and layer 82 for process results respectively. Images of the final samples cut from the Mirror Shield and 4Layer Mirror Shield. When cutting the Mirror Shield materials, edge quality was far superior when cutting with the PET layer facing upwards. Otherwise, the aluminum edge was jagged and rough.

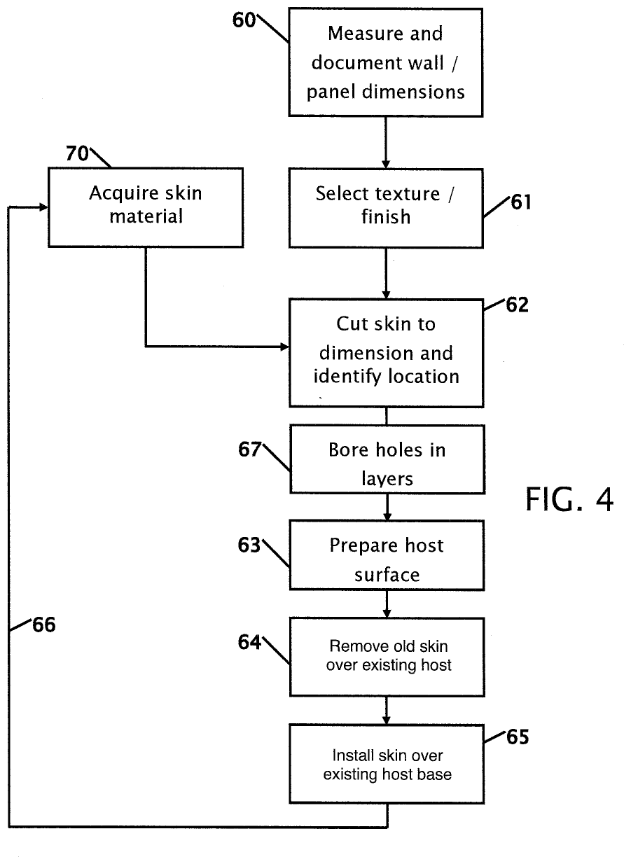

FIG. 4 shows the process that is used to prepare and cover a base surface with the graffiti covering skin. When the installation job is scheduled, one or more people will measure and document an entire job site. This could be a panel in an elevator, escalator, wall panel, counters, store front of windows, or transportation vehicle walls and or windows such as a train or bus. The process can further be applied to large areas such as an entire transit station or similar encompassing significant amounts of hard surfaces. The graffiti covering skin is applied in a wet process where the moisture is squeegeed out and air dried to create the removable bond.

Each panel is measured and documented 60 to ensure that cut pieces will be installed in the correct location with little or no trimming upon installation. This also ensure that if a panel needs to be replaced it can be cut and installed without requiring the panel to be re-measured.

The majority of the material used, predominantly, has a clear, obscuring, mirror, filtering, brushed or grain surface appearance. The cosmetic appearance can be from printing, painting, screening, brushing, or other processes. Other finishes can be selected as well as brush/grain direction can be selected 61. An obscuring or filtering can prevent clear vision through the material. The obscuring prevents visual acuity test using a 3 meter Snellen eye chart to obscure vision through the layers by an observer with 6 meter/9 meter vision to read a line on the eye chart. Raw material is ordered 70 based upon the calculated area that is being covered and scrap that may exist from trimming and installation. A computer algorithm combines pieces and adjusts orientation to accommodate shapes, angles to optimize the graffiti covering skin material 62. Each piece is cut and identified for the job and location for placement. The holes are then bored 67 to allow sequential removal of individual layers.

At the job site the host surface is prepared by cleaning or removal of previous adhesives, oils, gum or other foreign material 63 that might cause problems with installation or adherence of the graffiti covering skin. The graffiti covering skin is then centered and installed onto the host wall or existing base 64. Over a period of time a surface can be damaged from vandals, age or a desire to update an appearance. Because the area has been documented in the past, the previous skin can be removed 65 and replacement will be the selected 66 cut and replaced on the host surface. This process can be repeated when desired or required without damage to the underlying host surface.

Heat is not required for application of the covering skin in the installation process. The covering skin is designed to be removable without leaving any adhesive or other material that must be separately removed.

Thus, specific embodiments of a layered removable graffiti skin have been disclosed. It should be apparent, however, to those skilled in the art that many more modifications besides those described are possible without departing from the inventive concepts herein. The inventive subject matter, therefore, is not to be restricted except in the spirit of the appended claims.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method of forming a layered removable covering film for covering a surface from graffiti, said method comprising:
providing a substrate having a top surface and a bottom surface;
forming an adhesive layer including a removably secured release liner on the bottom surface of the substrate;
providing a plurality of removable film sheets and bonding the removable sheets together with acrylic bond wherein no air gaps are created between the removable film sheets thereby forming a laminated assembly; and
laser obliterating holes through the plurality of removable film sheets of the laminated assembly for sequential removal of the plurality of removable film sheets.

2. The method of claim 1 further comprising the step of:
forming the removable adhesive layer manually and not by a thermal vacuum process.

3. The method of claim 2 wherein the step of forming the removable adhesive layer is performed by forming an acrylic based pressure sensitive adhesive blend of self-cross linking acrylic polymers.

4. The method of claim 1 further comprising the step of:
providing an outer protective cosmetic layer on top of the topmost removable film sheet of laminated assembly.

5. The method of claim 1 further comprising the step of:
forming a protective cosmetic layer on the topmost layer of the multiple layers of the laminated assembly.

6. The method of claim 1 further comprising the step of:
inserting a tool into the obliterated holes to remove a single removable film sheet.

7. The method of claim 5 wherein the outer protective cosmetic layer is transparent or translucent.

8. The method of claim 1 where further including the step of:
forming the substrate between 0.0005″ to 0.0250″ thick.

9. The method of claim 1 further comprising the step of:
installing the laminate assembly to a host surface.
